(19) United States
(12) Patent Application Publication
(10) Pub. No.: US 2023/0349769 A1
(43) Pub. Date: Nov. 2, 2023

(54) A SYSTEM AND METHOD FOR AN INFRA-RED (IR) THERMOMETER WITH A BUILT-IN SELF-TEST

(71) Applicant: TYTO CARE LTD., Netanya (IL)

(72) Inventor: Eyal BYCHKOV, Hod Hasharon (IL)

(21) Appl. No.: 17/791,225

(22) PCT Filed: Jan. 12, 2021
(86) PCT No.: PCT/IL2021/050036

§ 371 Date: Jul. 7, 2022

Related U.S. Application Data
(60) Provisional application No. 62/960,715, filed on Jan. 14, 2020.

(51) Int. Cl. G01J 5/53; G01J 5/02

(52) U.S. Cl. CPC G01J 5/53; G01J 5/025; G01J 5/026; G01J 5/0265

(57) ABSTRACT

An Infra-Red (IR) thermometer with a built-in self-test, the IR thermometer comprising: an IR sensor configured to determine a temperature of an object based on thermal radiation emittance from the object; a thermal radiation generation source capable of emitting known thermal radiation upon receiving an instruction; a cap, comprising a reflective surface for reflecting thermal radiation generated by the thermal radiation generation source into the IR sensor upon the cap being in a closed position wherein the cap is covering a part of the IR thermometer including the IR sensor and the thermal radiation generation source, so that the IR sensor does not receive radiation from sources other than the thermal radiation generation source; and a processing circuitry configured to perform the built-in self-test by: instructing the thermal radiation generation source to emit the known thermal radiation, when the cap is in the closed position; obtaining at least one temperature measurement from the IR sensor after a time period required for the thermal radiation generation source to emit the known thermal radiation; and upon the temperature measurement deviating above a threshold from the expected temperature, generating a failure indication of failure of the built-in self-test or upon the temperature measurement deviating below the threshold from the expected temperature, generate a success indication of success of the built-in self-test.

### TECHNICAL FIELD

The invention relates to a system and method for an Infra-Red (IR) thermometer with a built-in self-test.

### BACKGROUND

Current Infra-Red (IR) thermometer technologies utilizes measurements of amounts of thermal radiation emitted by a measured object to infer the temperature of the measured object. This is usually achieved by focusing the infrared thermal radiation, through a lens, on to a detector, which converts the radiant power to an electrical signal that can be displayed in units of temperature after being compensated for ambient temperature. These thermometers are sensitive to dirt or dust accumulating on the lens and/or on the sensor, thus distorting the IR thermometer readings, thus there is a need for a physical IR thermometer with a built-in self-test that automatically tests the IR thermometer for dirt or dust.

There is thus a need in the art for a new method and system for an IR thermometer with a built-in self-test.

References considered to be relevant as background to the presently disclosed subject matter are listed below. Acknowledgement of the references herein is not to be inferred as meaning that these are in any way relevant to the patentability of the presently disclosed subject matter.

Japanese Patent No. 3885323 (SHIBUYA et al.) published on Feb. 21, 2007, discloses a problem to be solved: to maintain thermometric precision by informing a user of the fouling of an optical system, which leads infrared ray to an infrared sensor, with earwax or dewing. Solution: a thermometer comprises a light gathering means 15 (15a, 15b) to gather infrared ray radiated from near an eardrum, an infrared sensor 1 to detect infrared ray gathered by the light gathering means 15 (15a, 15b), a fouling detecting means 25 to detect the fouling of the light gathering means 15 (15a, 15b), an arithmetic control means 19 to convert the output of the infrared sensor 1 into body temperature information and judge fouling in accordance with information from the fouling detecting means 25 and an informing means 31 to inform of fouling in accordance with information from the arithmetic control means 19. In this way, a user is informed of the fouling of an optical system and thermometric precision is maintained.

Japanese Patent application No. 2008145133 (YOSHIAKI et al.) published on Jun. 26, 2008, discloses a problem to be solved: to provide a radiation thermometer capable of accurately calibrating the output value from a temperature measuring infrared detector that can have the measurement accuracy enhanced significantly in a prescribed temperature distribution, even if there is drift due to changes in the ambient temperature or the like, deterioration of sensitivity that accompany a long-term use, and contamination in optical system are generated. Solution: this radiation thermometer is provided with a compensating infrared detector 6 that has no self-heat generation, for receiving directly the infrared rays emitted from a shutter 5, and for measuring the surface temperature of the shutter 5 in a noncontact manner, based on the temperature of the received infrared ray, on a moving route of the shutter 5 for intermittently blocking or opening the visual field of the temperature-measuring infrared detector 3 for receiving the infrared rays emitted from a measuring object and comprising a thermistor bolometer type infrared detecting element 31 with a resistance value or a voltage value, that is varied in response to the temperature of the infrared rays, received, and the output value from the temperature measuring infrared detector 3 is calibrated, based on the measured output value from the compensating infrared detector 6.

US Patent application No. 2013/0259087 (Gerlitz) published on Oct. 3, 2013, discloses a method and apparatus for measuring temperature of a measured area of a surface without contacting the surface. The thermometer apparatus has an optical system which generates a correlative image of an infrared energy detector sensitive area at an image distance from the thermometer. A limiting aperture, having a size and a shape corresponding to those of the generated image, is between a mirror and the generated image. The measured area of the surface is between the generated image and the thermometer in use. With such a configuration, little infrared energy that does not originate from the measured area strikes the detector. Consequently, the energy reaching the detector is limited such that the size of the measured area remains constant, regardless of changes in the thermometer's field of view attributable to differences in the distance between the surface and the thermometer. A scan-and-integrate mode for practicing the invention is disclosed.

U.S. Pat. No. 5,066,142 (DeFrank et al.) published on Nov. 19, 1991, discloses a protective apparatus for a biomedical thermometer having a protruding probe containing a waveguide includes mounting a transparent window at the patient end of the waveguide to seal the waveguide from contamination while permitting infrared energy to pass. A protective sleeve protects and mounts the transparent window to the waveguide and material is provided along the entire probe-length of the waveguide to protect it. An outer boot is mounted over the transparent window and waveguide protection material to provide further protection and to supply a mounting and retaining surface for a protective probe cover. A disposable protective probe cover having a generally thin, flat, frame member with an aperture therethrough, is sized to fit over and be retained over the base of the probe by a friction interference fit. Extending across the aperture of the probe cover frame member is a material which stretches to generally conform to the shape of the probe when the tip of the probe is inserted through the aperture of the frame. A probe cover sensor is provided to indicate the existence of a protective probe cover.

US Patent application No. 2015/0124336 (Kaufman) published on May 7, 2015, relates to wide spectrum optical systems and devices for use in multispectral imaging systems and applications and in particular, wide spectrum optical assemblies that are implemented using low cost, first surface mirrors in an optical framework that enables real-time viewing of an image in multiple spectral bands simultaneously over the same optical centerline with one main optical element.

U.S. Pat. No. 6,371,925 (Imai et al.) published on Apr. 16, 2002, discloses a radiation thermometer measures temperature of the eardrum. The thermometer comprises a signal processor for calculating a temperature from an output of a light receptor, which receives only the infrared rays radiated directly from the eardrum and/or vicinity of it, and a notification system for notifying the temperature resulted from the calculation. Since the structure does not receive an influence of any radiant heats from other than those of the eardrum and/or vicinity of it, temperature change of a probe does not become a factor of measuring errors, so as to offer an accurate measurement of temperatures. An infrared-receiving element is positioned within a triangle configured by an intersection between a light path and an optical axis, and two image points of hypothetical end points formed by an optical condenser, when viewed in a cross sectional plane including the optical axis of the optical condenser, where (a) the light path is a path that extends from the hypothetical end point to the image point of the hypothetical end point formed by the optical condenser by passing through a rim of the optical condenser on the same side as the hypothetical end point with respect to the optical axis, and (b) the hypothetical end point is a point at which a straight line drawn from the rim of the optical condenser toward the probe in a manner to be tangent to an inner surface of the probe on the same side as the rim of the optical condenser with respect to the optical axis crosses a plane at a tip of the probe.

German Patent application No. 02013105074 (Dittmann) published on Nov. 19, 2013, discloses a radiation thermometer for the non-invasive temperature measurement of the human body, in particular infrared thermometer, comprising a housing (1), an attached on the housing (1) measuring head (4) which in turn consists of a lens (5) and a radiation sensor and with a electronic circuit for detecting and evaluating the signals of the radiation sensor is connected, wherein the electronic circuitry drives a temperature indicator (2), characterized, in that both a display (3) for carrying out a cleaning operation for the measuring head (4) and in particular the lens (5) is contained impurities, and a detector for detecting on the surface of the lens (5) is present which drives the circuit which is activated on exceeding a certain minimum value, the display (3).

### General Description

In accordance with a first aspect of the presently disclosed subject matter, there is provided an Infra-Red (IR) thermometer with a built-in self-test, the IR thermometer comprising: an IR sensor configured to determine a temperature of an object based on thermal radiation emittance from the object; a thermal radiation generation source capable of emitting known thermal radiation upon receiving an instruction; a cap, comprising a reflective surface for reflecting thermal radiation generated by the thermal radiation generation source into the IR sensor upon the cap being in a closed position wherein the cap is covering a part of the IR thermometer including the IR sensor and the thermal radiation generation source, so that the IR sensor does not receive radiation from sources other than the thermal radiation generation source; and a processing circuitry configured to perform the built-in self-test by: instructing the thermal radiation generation source to emit the known thermal radiation, when the cap is in the closed position; obtaining at least one temperature measurement from the IR sensor after a time period required for the thermal radiation generation source to emit the known thermal radiation; and upon the temperature measurement deviating above a threshold from the expected temperature, generating a failure indication of failure of the built-in self-test or upon the temperature measurement deviating below the threshold from the expected temperature, generate a success indication of success of the built-in self-test.

In some cases, the processing circuitry is further configured to alert a user of the IR thermometer of the failure of the built-in self-test upon generating the failure indication.

In some cases, the processing circuitry is further configured to provide a user of the IR thermometer with an instruction to clean the IR thermometer.

In some cases, the thermal radiation generation source includes at least one Light-Emitting Diode (LED).

In some cases, the processing circuitry is further configured to send results of the built-in self-test over a communication network to a medical practitioner workstation.

In accordance with a second aspect of the presently disclosed subject matter, there is provided a method for a self-test of an Infra-Red (IR) thermometer comprising: instructing, by a processing circuitry, a thermal radiation generation source of the IR thermometer to emit a known thermal radiation, when a cap of the IR thermometer, is in a closed position, wherein the cap comprising a reflective surface for reflecting thermal radiation generated by the thermal radiation generation source into an IR sensor of the IR thermometer, the IR sensor configured to determine a temperature of an object based on thermal radiation emittance from the object, upon the cap being in the closed position wherein the cap is covering a part of the IR thermometer including the IR sensor and the thermal radiation generation source, so that the IR sensor does not receive radiation from sources other than the thermal radiation generation source; obtaining, by the processing circuitry, at least one temperature measurement from the IR sensor after a time period required for the thermal radiation generation source to emit the known thermal radiation; and upon the temperature measurement deviating above a threshold from the expected temperature, generating, by the processing circuitry, a failure indication of failure of the built-in self-test or upon the temperature measurement deviating below the threshold from the expected temperature, generate a success indication of success of the built-in self-test.

In some cases, the method further comprising alerting, by the processing circuitry, a user of the IR thermometer of the failure of the built-in self-test upon generating the failure indication.

In some cases, the method further comprising providing, by the processing circuitry, a user of the IR thermometer with an instruction to clean the IR thermometer.

In some cases, the thermal radiation generation source includes at least one Light-Emitting Diode (LED).

In some cases, the method further comprising sending, by the processing circuitry, results of the built-in self-test over a communication network to a medical practitioner workstation.

In accordance with a third aspect of the presently disclosed subject matter, there is provided a non-transitory computer readable storage medium having computer readable program code embodied therewith, the computer readable program code, executable by at least one processor of a computer to perform a method comprising: instructing, by the processor, a thermal radiation generation source of the IR thermometer to emit a known thermal radiation, when a cap of the IR thermometer, is in a closed position, wherein the cap comprising a reflective surface for reflecting thermal radiation generated by the thermal radiation generation source into an IR sensor of the IR thermometer, the IR sensor configured to determine a temperature of an object based on thermal radiation emittance from the object, upon the cap being in the closed position wherein the cap is covering a part of the IR thermometer including the IR sensor and the thermal radiation generation source, so that the IR sensor does not receive radiation from sources other than the thermal radiation generation source; obtaining, by the processor, at least one temperature measurement from the IR sensor after a time period required for the thermal radiation generation source to emit the known thermal radiation; and upon the temperature measurement deviating above a threshold from the expected temperature, generating, by the processor, a failure indication of failure of the built-in self-test or upon the temperature measurement deviating below the threshold from the expected temperature, generate a success indication of success of the built-in self-test.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of a system for performing a medical examination of a patient by a remote medical practitioner, in accordance with the presently disclosed subject matter,

FIG. 2 is a block diagram schematically illustrating one example of an IR thermometer with a built-in self-test, in accordance with the presently disclosed subject matter,

FIG. 3 is a schematic illustration of an example environment of a system for an IR thermometer with a built-in self-test, in accordance with the presently disclosed subject matter, and

FIG. 4 is a flowchart illustrating one example of a sequence of operations carried out for performing a built-in self-test, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “instructing”, “obtaining”, “generating”, “alerting”, “providing” or the like, include action and/or processes of a computer that manipulate and/or transform data into other data, said data represented as physical quantities, e.g. such as electronic quantities, and/or said data representing the physical objects. The terms “computer”, “processor”, “processing resource” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

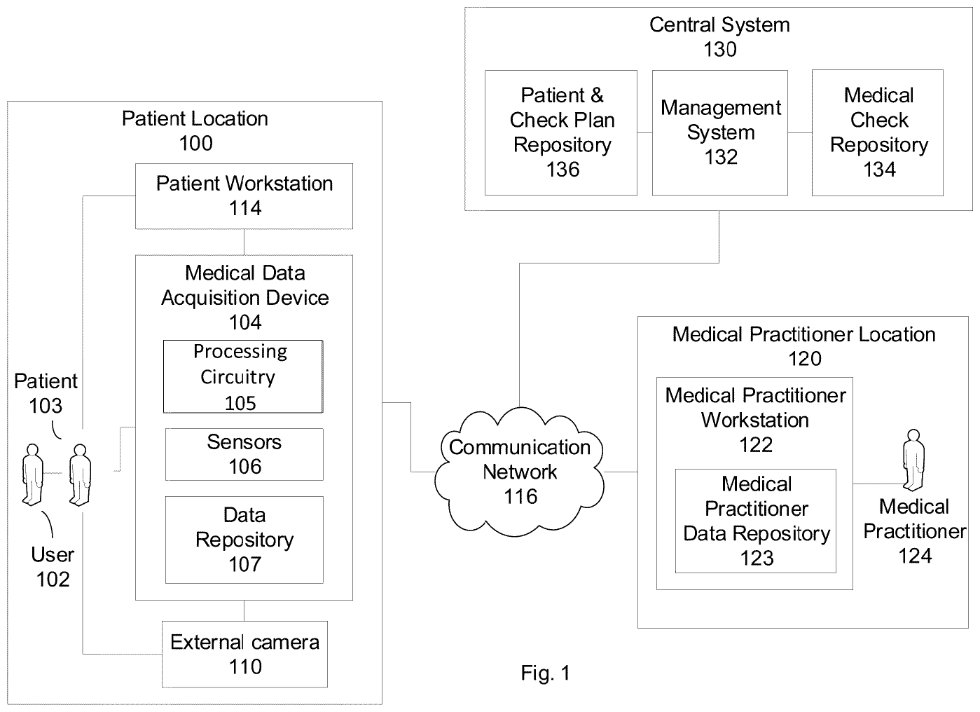

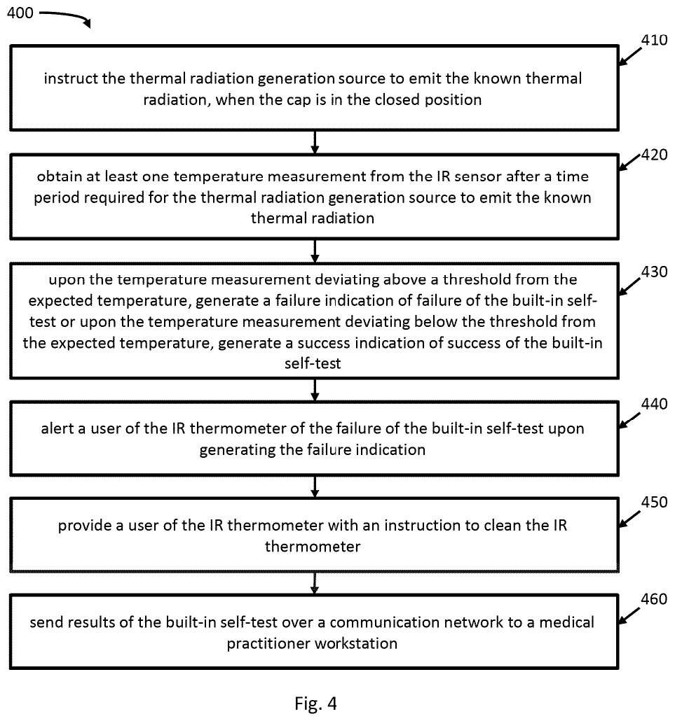

In embodiments of the presently disclosed subject matter, fewer, more and/or different stages than those shown in FIG. 4 may be executed. In embodiments of the presently disclosed subject matter one or more stages illustrated in FIG. 4 may be executed in a different order and/or one or more groups of stages may be executed simultaneously. FIGS. 1-3 illustrate a general schematic of the system architecture in accordance with an embodiment of the presently disclosed subject matter. Each module in FIGS. 1-3 can be made up of any combination of software, hardware and/or firmware that performs the functions as defined and explained herein. The modules in FIGS. 1-3 may be centralized in one location or dispersed over more than one location. In other embodiments of the presently disclosed subject matter, the system may comprise fewer, more, and/or different modules than those shown in FIGS. 1-3.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, a block diagram schematically illustrating one example of a system for performing a medical examination of a patient by a remote medical practitioner, in accordance with the presently disclosed subject matter. A user 102 and a patient 103 (a person or an animal whose medical examination is required) are located at patient location 100, and a medical practitioner 124 is located at a medical practitioner location 120, remote from the patient location 100. In fact, according to the presently disclosed subject matter, the medical practitioner 124 is located at the medical practitioner location 120 that is remote from the patient location 100 so that the medical practitioner 124 does not have direct access to the patient 103 (e.g. it is not located in the same room with the patient 103, nor in any other form of vicinity thereto, so that the medical practitioner 124 cannot himself hold the medical data acquisition device 104 and place it on the body of the patient 103 for acquiring medical data therefrom). In some cases, the medical practitioner 124 can be located in a different room/floor/building/street/city/state/country/continent than the patient 103.

In light of the fact that the medical practitioner 124 is located at a different location than the patient 103, the user 102 is required to operate the medical data acquisition device 104 for acquiring medical data from the patient's 103 body. In this respect, it is to be noted that the user 102 can be the patient 103 whose medical examination is required (in such cases, even though user 102 and patient 103 are shown as separate entities in the drawings, they are in fact the same entity). In other cases, the user 102 can be another person (other than patient 103) that will operate the medical data acquisition device 104 for acquiring medical data from the patient's 103 body, as further detailed herein. In some cases, the user 102 is not a medical practitioner, i.e. the user 102 is not a person specifically trained to acquire medical data from the patient's 103 body, nor is he qualified to diagnose a medical condition of the patient 103 based on medical data acquired from the patient's body.

Attention is drawn to the components within the patient location 100:

The medical data acquisition device 104 comprises (or is otherwise associated with) at least one processing circuitry 105. Processing circuitry 105 can be one or more processing units (e.g. central processing units), microprocessors, microcontrollers (e.g. microcontroller units (MCUs)) or any other computing/processing device, which are adapted to independently or cooperatively process data for controlling relevant medical data acquisition device 104 resources and for enabling operations related to medical data acquisition device 104 resources.

Medical data acquisition device 104 further comprises one or more sensors 106 (e.g. camera/s, microphone/s, a thermometer, depth camera/s, an otoscope, a blood pressure sensor, an electrocardiogram (ECG), an ultrasound sensor, an acoustic sensor, a blood saturation sensor, etc.), including at least one sensor capable of acquiring medical data from the patient's 103 body, based on which the medical practitioner 124 can diagnose a medical condition of the patient 103. The medical data can be, for example, body temperature, blood pressure, blood saturation, ECG measurements, audio signals (e.g. of the heart operations or of the lungs), ultrasound signals (e.g. of the heart, of the intestines, etc.), acoustic measurements, body tissue electrical resistance, hardness of body tissues, a heartrate, an image or a video recording of a body organ or a portion of a body organ (whether internal body organ or external body organ), a 3D representation of one or more body organs or portions thereof (whether internal body organ or external body organ), a blood sample analysis, urine samples, throat cultures, saliva samples, or any other parameter associated with one or more physiological characteristic of a patient, based on which diagnosis can be provided.

In some cases, medical data acquisition device 104 can further comprise, or be otherwise associated with, a data repository 107 (e.g. a database, a storage system, a memory including Read Only Memory-ROM, Random Access Memory-RAM, or any other type of memory, etc.) configured to store data, including inter alia patient-related data relating to one or more patients 103 and various medical data acquired from such patients 103 body (e.g. data acquired during a medical examination of the patients using the medical data acquisition device 104), various configuration parameters of the sensor(s) 106, check plans for patient 103 (e.g. defining medical examinations to be performed on patient 103), threshold parameters (e.g. defining required quality levels for various types of measurements), etc. In some cases, data repository 107 can be further configured to enable retrieval and/or update and/or deletion of the stored data. It is to be noted that in some cases, data repository 107 can be distributed across multiple locations, whether within the medical data acquisition device 104 and/or within patient location 100 and/or within central system 130 and/or within medical practitioner location 120 and/or elsewhere. It is to be noted, that in some cases, the relevant information relating to the patient 103 can be loaded into data repository 107 before performing medical examination of the 103 (e.g. upon beginning of a medical examination and/or periodically and/or upon an entity such as the medical practitioner 124 requesting the information).

It is to be noted that in some cases, the medical data acquisition device 104 can be a handheld device, and at least the processing circuitry 105 and the sensors 106 can be comprised within a housing of the medical data acquisition device 104, that can optionally be a handheld device. In some cases, the sensors can be comprised within removably attachable units configured to be attached to the medical data acquisition device 104. In some cases, the sensors can be external to the medical data acquisition device 104 and in such cases, it may communicate with the medical data acquisition device 104 via a wired connection and/or via a wireless connection (e.g. a WiFi connection).

It is to be further noted that in some cases, medical data acquisition device 104 can further comprise one or more speakers for providing audio recordings to the user 102 (e.g. recordings of a medical practitioner 124 instructing the user 102 how to perform medical examinations, voice instructions generated by the medical data acquisition device 104 instructing the user 102 how to perform medical examinations, etc.). Medical data acquisition device 104 can further comprise a microphone for recording sounds, including voices (e.g. of the user 102 and/or patient 103), in the vicinity of the medical data acquisition device 104, e.g. during medical examinations conducted using the medical data acquisition device 104. Medical data acquisition device 104 can further comprise a display for providing visual output to the user 102 (e.g. a video recording of a remote medical practitioner 124, computer generated instructions instructing the user 102 how to perform medical examinations, indications of quality of an acquired measurement, etc.).

In some cases, medical data acquisition device 104 can communicate, directly, or indirectly, with patient workstation 114 and/or with medical practitioner workstation 122 and/or with central system 130, through communication network 116 (e.g. the Internet), via wired or wireless communication. It is to be noted that such communication can alternatively or additionally be performed utilizing other known communication alternatives, such as a cellular network, Virtual Private Network (VPN), Local Area Network (LAN), etc.

In some cases, a camera 110 can also be located at the patient location 100. Camera 110 (also referred to as “external camera 110”) is external to medical data acquisition device 104, in the sense that it is not comprised within the housing of the medical data acquisition device 104. Camera 110 is preferably movable irrespectively of medical data acquisition device 104. Camera 110 is operable to capture visible light, and to generate images or video based on light it captures. Camera 110 may additionally, or alternatively, be sensitive to other parts of the electromagnetic spectrum near the visible spectrum (e.g. to infrared radiation, such as near IR radiation). Camera 110 may be sensitive to the entire visible spectrum (e.g. a commercial-off-the-shelf camera, such as a DSLR camera, a smartphone camera, a webcam camera), or only to a part of it. In some cases, the camera 110 can be a depth camera, capable of generating a 3D representation of the examination process.

Camera 110 is oriented toward the examined patient's 103 body location, in at least some of the time during which medical data acquisition device 104 acquires medical data from the patient's 103 body. Especially, camera 110, when oriented toward the examined patient's 103 body location (as described), is operable to acquire one or more images (that can optionally form a video) which includes at least a part of the patient's 103 body and at least part of the medical data acquisition device 104 when medical data acquisition device 104 (or one or more of the sensors 106) is adjacent to the examined patient 103 body location. Accordingly, images capture by the camera 110 include at least part of the medical data acquisition device 104 and a location on the body of the patient 103 which is currently examined thereby.

In some cases, a patient workstation 114 can also be located at the patient location 100. Patient workstation 114 can be any computer, including a personal computer, a portable computer, a smartphone or any other apparatus with appropriate processing capabilities, including an apparatus which can be, for example, specifically configured for that purpose. The patient workstation 114 can be operated by user 102, for receiving inputs therefrom (e.g. questions to answers, various identification information, etc.), and/or for providing output thereto (showing operational instructions for operating the medical data acquisition device 104, etc.). In some cases, patient workstation 114 can communicate with medical data acquisition device 104 and/or with medical practitioner workstation 122 and/or with central system 130, through communication network 116 (e.g. the Internet), via wired or wireless communication. It is to be noted that such communication can alternatively or additionally be performed utilizing other known communication alternatives, such as a cellular network, Virtual Private Network (VPN), Local Area Network (LAN), etc. It is to be noted that in some cases, patient workstation 114 can comprise the camera 110, and in a more specific example, patient workstation 114 can be a smartphone and camera 110 can be a camera of the smartphone. It is to be noted that in some cases, the processing circuitries of the patient workstation 114, or of any other computer (located at the patient location 100 or elsewhere), can perform some of the tasks described with reference to processing circuitry 105 of the medical data acquisition device 104.

Attention is drawn to the components within the medical practitioner location 120:

A medical practitioner workstation 122 is located at the medical practitioner location 120. Medical practitioner workstation 122 can be any computer, including a personal computer, a portable computer, a smartphone or any other apparatus with appropriate processing capabilities, including an apparatus which can be, for example, specifically configured for that purpose. The medical practitioner workstation 122 can receive inputs from the medical practitioner 124 (e.g. instructions and/or questions to be provided to the user 102 and/or patient 103, etc.), and/or provide output to the medical practitioner 124 (showing the medical data acquired by the medical data acquisition device 104, etc.). In some cases, medical practitioner workstation 122 can communicate with medical data acquisition device 104 and/or patient workstation 114 and/or central system 130, through communication network 116 (e.g. the Internet), via wired or wireless communication. It is to be noted that such communication can alternatively or additionally be performed utilizing other known communication alternatives, such as a cellular network, VPN, LAN, etc. In some cases, medical practitioner workstation 122 can communicate with one or more other medical practitioner workstations 122, e.g. when a first medical practitioner operating the medical practitioner workstation 122 is interested in obtaining a second opinion, optionally relating to a certain diagnosis provided by the first medical practitioner, from another medical practitioner.

In some cases, medical practitioner workstation 122 can further comprise, or be otherwise associated with, a medical practitioner data repository 123 (e.g. a database, a storage system, a memory including Read Only Memory-ROM, Random Access Memory-RAM, or any other type of memory, etc.) configured to store data, including inter alia medical data acquired by the medical data acquisition device 104 (optionally including also various metadata relating to such medical data), and other patient-related data relating to one or more patients 103. In some cases, medical practitioner data repository 123 can be further configured to enable retrieval and/or update and/or deletion of the stored data. It is to be noted that in some cases, medical practitioner data repository 123 can be distributed across multiple locations, whether within the medical practitioner location 120 and/or within central system 130 and/or elsewhere. It is to be noted, that in some cases, the relevant information relating to a given examined patient 103 can be loaded into data repository 123 before performing medical examination of a patient 103 (e.g. upon beginning of a medical examination and/or periodically and/or upon an entity such as the medical practitioner 124 requesting the information). In some cases, the medical data can include Electronic Health Records (EHR) data relating to one or more patients 103. In some cases, the EHR data can be obtained through an interface (e.g. over the communication network 116) to a remote EHR system.

In some cases, medical practitioner system 122 can communicate with patient workstation 144 and/or with medical data acquisition device 104 and/or with central system 130, through communication network 116 (e.g. the Internet), via wired or wireless communication. It is to be noted that such communication can alternatively or additionally be performed utilizing other known communication alternatives, such as a cellular network, Virtual Private Network (VPN), Local Area Network (LAN), etc.

In some cases, a central system 130 can exist, for allowing a distributed approach in which medical data and/or other patient-related data can be received by the central system 130 from multiple patient locations 100 and transferred by it to multiple medical practitioner locations 120. Thus, in case the transmitted medical data and/or other patient-related data is received at central system 130, it can be stored in medical check repository 134 and management system 132 can transmit it to a specific medical practitioner location 120 (e.g. via communication network 116 such as the Internet). In some cases, management system 132 can also manage other processes such as, subscribing patients, planning scheduling of patients to available medical practitioners, etc.

It is to be noted that central system 130 is optional to the solution and that central system 130 can be part of the medical practitioner workstation 122. In addition, the communication between the patient workstation 114 and/or the medical data acquisition device 104, and the medical practitioner workstation 122 can be performed directly without the use of or need for a central system 130.

In those cases where a central system 130 exists, it can comprise patient & check plan repository 136 in which various patient-related data, relating to one or more patients 103, is maintained. Such patient-related data can include, for example, patient identification number, patient name, patient age, patient contact details, patient medical record data (such as the patients EHR, information of patient's diseases, sensitivities to medicines, etc.), check plans data (as further detailed below), etc. Central system 130 can further comprise a medical check repository 134 in which one or more of the following can be stored; (a) medical data acquired by medical data acquisition device 104 (optionally including also various metadata relating to such medical data), (b) user-provided data, provided by the user 102, e.g. using the patient workstation 114, including type-ins and/or voice recording and/or additional info provided by user 102 and relating to the patient 103, and (c) diagnosis data provided by a medical practitioner diagnosing the patient 103. The medical data and/or the user-provided data, can include, for example, voice recordings and/or video recordings and/or values of one or more of the following parameters: body temperature, blood pressure, blood saturation, electrocardiogram (ECO) measurements, audio signals (e.g. of the heart operations or of the lungs), ultrasound signals (e.g. of the heart, of the intestines, etc.), acoustic measurements, body tissue electrical resistance, hardness of body tissues, a heartrate, an image or a video recording of a body organ or a portion of a body organ (whether internal body organ or external body organ), a blood sample analysis, a 3D representation of one or more body organs or portions thereof (whether internal body organ or external body organ), urine samples, throat cultures, saliva samples, or any other parameter associated with one or more physiological characteristic of a patient, based on which diagnosis can be provided. In some cases, one or more of the parameter values can be associated with metadata, such as a timestamp indicative of the time in which the parameter value was acquired, location data indicative of the location at which the parameter value was acquired (e.g. geographical coordinates, WiFi Internet Protocol (IP) address, etc.), a sensor type, information enabling identification of a specific sensor with which the parameter value was acquired, Inertial Navigation System (INS) and/or pressure sensor and/or room humidity and/or room temperature and/or patient orientation and/or room ambient noise level readings acquired during acquisition of the parameter value.

Central system 130 can further comprise management system 132 configured to forward medical data acquired by the medical data acquisition device 104 (whether in a raw form, or any processed version of the raw data acquired by the medical data acquisition device 104) and relating to a patient 103, and optionally other patient-related data relating to the patient 103, to a selected medical practitioner workstation 122 (for example an available medical practitioner workstation 122 or medical practitioner workstation 122 with the shortest queue, e.g. in case where no medical practitioner, out of a plurality of medical practitioners, is currently available). It is to be noted that when providing a central system 130, there may be more than one medical practitioner location 120 and more than one medical practitioner 124 as central system 130 can allow the distributed approach in which data (e.g. medical data and/or other patient-related) can be received by the central system 130 from multiple patient locations 100 and transferred by it to multiple medical practitioner locations 120.

Having described the various components in the patient location 100, in the medical practitioner location 120 and the central system 130, attention is drawn to two exemplary modes of operation of the medical data acquisition device 104: an on-line mode and an off-line mode.

In an on-line mode, a medical examination of the patient 103 is conducted while the medical practitioner 124 is actively involved in the process. In such operation mode, the medical practitioner 124 can be provided with a video or a sequence of images, based on which the medical practitioner 124 provides the user 102 with instructions for positioning the medical data acquisition device 104 with respect to the patient's 103 body. In addition, the medical practitioner 124 can provide the user 102 with instructions for performing a current medical examination (other than positioning instructions) and/or with instructions for performing other medical examinations as part of the medical examination flow. In some cases, the instructions can be audible instructions, acquired by a microphone on the medical practitioner location (e.g. a microphone connected to the medical practitioner workstation 122), and provided to the user 102 via a speaker in the patient location 100 (e.g. a speaker of the medical data acquisition device 104, a speaker of the patient workstation 114, or any other speaker which provides sounds that the user 102 can hear). Additionally, or alternatively to the audible instructions, the instructions can be video instructions provided via a display in the patient location 100 (e.g. a display of the medical data acquisition device 104, a display of the patient workstation 114, or any other display visible to the user 102).

The video that is provided to the medical practitioner 124 can be acquired by a camera comprised within the medical data acquisition device 104 (e.g. one of the sensors 106 can be a camera used for this purpose), and in such case, the medical practitioner 124 can view the part of the patient's body to which the camera is aimed. In additional, or alternative cases, the video can be acquired by an external camera 110 external to the medical data acquisition device 104, and in such cases, the medical practitioner 124 can view the patient 103 and the medical data acquisition device 104 in the same frame. In any case, based on the camera's view, the medical practitioner 124 can provide the user 102 with maneuvering instructions for navigating the medical data acquisition device 104 to a desired spatial disposition with respect to the patient's 103 body. In some cases, the video can be accompanied by a sound recording acquired using a microphone located at the patient location 100 (e.g. a microphone of the medical data acquisition device 104, a microphone of the patient workstation 114, or any other microphone that can acquire a sound recording of sounds at the patient location 100)

Upon arrival of the medical data acquisition device 104 to the desired spatial disposition (from which the medical data can be acquired) with respect to the patient's 103 body, the medical practitioner 124 can instruct the user 102 to acquire the medical data, or it can operate the sensors 106 himself to acquire the medical data. In some cases, the medical practitioner 124 can also remotely control various parameters of the sensors 106, e.g. through medical practitioner workstation 122.

It is noted that medical data acquisition device 104 can be located outside the body of the patient when acquiring the medical data. Nevertheless, in some cases some parts of medical data acquisition device 104 may enter the body of the patient (e.g. a needle penetrating the skin and/or a blood vessel, a sensor entering a body orifice such as the ear or the mouth, and so on). Even in such cases, the greater part of medical data acquisition device 104 can be located outside the body at the time of measurement.

The medical data acquired by the medical data acquisition device 104 can be transmitted to the medical practitioner workstation 122 (directly, or through the patient workstation 114 and/or through the central system 130 where it can be stored in the medical check repository 134 in association with the patient 103 from which the medical data was acquired), where it can be stored in medical practitioner data repository 123 in association with the patient 103 from which the medical data was acquired.

The medical practitioner 124 (e.g. a doctor, a nurse, a medic, etc., including any other person with the know-how and skill to acquire and/or analyze medical data), located at medical practitioner location 120, can review the acquired medical data, for example using medical practitioner workstation 122. It is to be noted that patient workstation 114, medical practitioner workstation 122 and central system 130 can include a display (e.g. LCD screen), and a keyboard or any other suitable input/output devices.

In some cases, medical practitioner 124 can provide feedback data (e.g. by transmitting corresponding instructions to patient workstation 114 and/or to medical data acquisition device 104) to user 102, such as a diagnosis, one or more prescriptions, or instructions to perform one or more additional medical examinations. Alternatively, or additionally, medical practitioner 124 can transmit feedback data to central system 130, which, in turn, can optionally transmit the feedback data to patient workstation 114 and/or to the medical data acquisition device 104 (e.g. via the communication network 116).

In some cases, the medical data acquisition device 104 and/or the patient workstation 114 can be configured to provide the user 102 with an indication of a quality of a signal acquired by the sensors. In such cases, the medical data acquisition device 104 and/or the patient workstation 114 can be configured to determine the signal quality and display an appropriate indication on a display visible by the user 102 (e.g. a display of the medical data acquisition device 104 and/or a display of the patient workstation 114). In some cases, upon the signal quality not meeting pre-defined thresholds, the medical data acquisition device 104 and/or the patient workstation 114 can be configured to provide the user 102 with instructions for improving the acquired signal quality (e.g. instructions to reposition the medical data acquisition device 104, instructions to reduce ambient noise, etc.).

In an off-line mode, a medical examination of the patient 103 is conducted while no medical practitioner 124 is actively involved in the process. In such operation mode, the medical data acquisition device 104 can provide the user 102 with audio and/or video navigation instructions for navigating the medical data acquisition device 104 to a desired spatial disposition with respect to the patient's 103 body. The navigation instructions can be determined by the medical data acquisition device 104 and/or by the patient workstation 114 using information obtained from an Inertial Navigation System (INS), that can optionally be part of the sensors 106, and/or using matching of reference points within reference images and images acquired by a camera comprised within the medical data acquisition device 104 and/or by external camera 110. The navigation instructions can be provided via a speaker and/or a display of the medical data acquisition device 104 and/or of the patient workstation 114 and/or of any other device located near the user 102 in a manner that enables a user to hear and/or see the navigation instructions.

Upon arrival of the medical data acquisition device 104 to the desired spatial disposition (from which the medical data can be acquired) with respect to the patient's 103 body, the user 102 can operate the medical data acquisition device 104 to acquire medical data, or alternatively, the medical data acquisition device 104 can acquire the medical data automatically.

In some cases, the medical data acquisition device 104 and/or the patient workstation 114 can be configured to provide the user 102 with an indication of a quality of a signal acquired by the sensors. In such cases, the medical data acquisition device 104 and/or the patient workstation 114 can be configured to determine the signal quality and display an appropriate indication on a display visible by the user 102 (e.g. a display of the medical data acquisition device 104 and/or a display of the patient workstation 114). In some cases, upon the signal quality not meeting pre-defined thresholds, the medical data acquisition device 104 and/or the patient workstation 114 can be configured to provide the user 102 with instructions for improving the acquired signal quality (e.g. instructions to reposition the medical data acquisition device 104, instructions to reduce ambient noise, etc.).

It is noted that medical data acquisition device 104 can be located outside the body of the patient when acquiring the medical data. Nevertheless, in some cases some parts of medical data acquisition device 104 may enter the body of the patient (e.g. a needle penetrating the skin and/or a blood vessel, a sensor entering a body orifice such as the ear or the mouth, and so on). Even in such cases, the greater part of medical data acquisition device 104 can be located outside the body at the time of measurement.

The medical data acquired by the medical data acquisition device 104 can be transmitted to a medical practitioner workstation 122 (directly, or through the patient workstation 114 and/or through the central system 130 where it can be stored in the medical check repository 134 in association with the patient 130 from which the medical data was acquired), where it can be stored in medical practitioner data repository 123 in association with the patient 130 from which the medical data was acquired.

In some cases, the medical data is acquired by the medical data acquisition device's 104 sensors 106 can be transmitted to the medical practitioner workstation 122 in two (or more) different channels, while the medical data sent via each channel has a different quality.

For example, a first channel can include the medical data in a first quality, that is sufficient for enabling the medical practitioner 124 to provide the user 102 with navigation and/or positioning instructions for navigating the medical data acquisition device 104 to a desired spatial disposition with respect to the patient's 103 body, and/or for placing the medical data acquisition device 104 at a desired placement (e.g. a desired pressure level) with respect to the patient's 103 body. A second channel can include the medical data in a second quality, better/higher than the first quality, that is more likely to enable the medical practitioner 124 to accurately diagnose the patient 103 (e.g. enabling the medical practitioner 124 to determine if noises in readings which include a recording of the lungs are related to a medical condition of the patient 103 or simply reading noise, or to determine if a suspicious area on the patient's 103 skin is dirt or a mole that requires analysis).

The medical practitioner 124 (e.g. a doctor, a medic, etc., including any other entity (human or computerized) with the know-how and skill to acquire and/or analyze medical data), located at medical practitioner location 120, can review the acquired medical data, for example using a display and/or a speaker and/or any other suitable output device of the medical practitioner workstation 122. It is to be noted that patient workstation 114, medical practitioner workstation 122 and central system 130 can include a display (e.g. LCD screen), and a keyboard or any other suitable input/output devices.

In some cases, medical practitioner 124 can provide feedback data (e.g. by transmitting corresponding instructions to patient workstation 114 and/or to medical data acquisition device 104) to user 102, such as a diagnosis, one or more prescriptions, or instructions to perform one or more additional medical examinations. Alternatively, or additionally, medical practitioner 124 can transmit feedback data to central system 130, which, in turn, can optionally transmit the feedback data to patient workstation 114 (e.g. via the communication network 116). As indicated herein, the feedback data can be provided to the user 102 via an output device (e.g. a display, a speaker, etc.) of the medical data acquisition device 104 and/or of the patient workstation, or of any other device that is capable of providing the respective output to the user 102.

It is to be noted that in some cases, the medical practitioner data repository 123 and/or the data repository 107, and or the medical check repository 134 and/or the patient & check plan repository 136 can be the same single data repository, whether distributed or not, that is accessible by all relevant entities

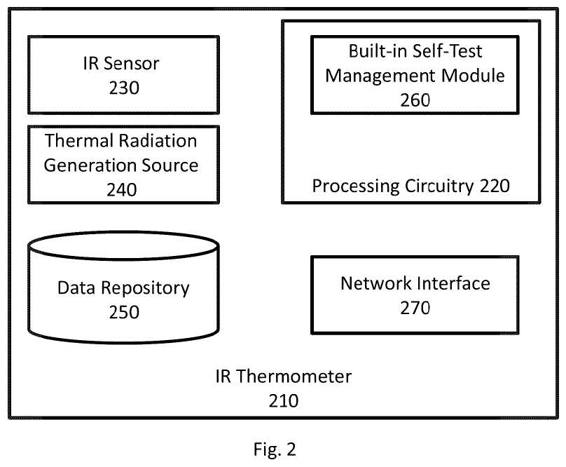

Bearing this in mind, attention is drawn to FIG. 2, a block diagram schematically illustrating one example of an IR thermometer with a built-in self-test, in accordance with the presently disclosed subject matter.

It is to be noted that IR thermometer 210 can be at least part of medical data acquisition device 104.

According to certain examples of the presently disclosed subject matter, IR thermometer 210 comprises an IR sensor 230 that measures at least portions of amounts of thermal radiation emitted by a measured object to infer the temperature of the measured object. This can be achieved for example by focusing the infrared thermal radiation, through a lens, on to a detector, which converts the radiant power to an electrical signal that can be displayed in units of temperature after being compensated for ambient temperature.

In some cases, IR thermometer 210 can measure temperature from a distance, without contact of IR thermometer 210 with the measured object.

In some cases, IR thermometer 210 can be a tympanic thermometer, measuring the thermal radiation from a tympanic membrane, for example: by inserting at least part of the IR thermometer 210 within an ear canal of the measured object.

IR thermometer 210 further comprises a thermal radiation generation source 240. Thermal radiation generation source 240 is capable of emitting known thermal radiation upon receiving an instruction. Thermal radiation generation source 240 can be any heat emitting element. For example, thermal radiation generation source 240 can be a light source that in some cases can be also used for illumination of at least part of the measured object. The thermal radiation generation source 240 emits thermal radiation that can be sensed by the IR sensor 230.

In some cases, thermal radiation generation source 240 includes at least one Light-Emitting Diode (LED).

IR thermometer 210 can further comprise, or be otherwise associated with, a data repository 250 (e.g. a database, a storage system, a memory including Read Only Memory-ROM, Random Access Memory-RAM, or any other type of memory, etc.) configured to store data, including, inter alia, historical built-in self-tests information including: when the built-in self-test was performed, success or failure indication of the built-in self-test, etc. Data repository 250 can be further configured to enable retrieval and/or update and/or deletion of the stored data. It is to be noted that in some cases, data repository 250 can be distributed, while the IR thermometer 210 has access to the information stored thereon, e.g. via a wired or wireless network to which IR thermometer 210 is able to connect to.

IR thermometer 210 can optionally comprise a network interface 270 (e.g. a network card, a WiFi client, a LiFi client, 3G/4G client, or any other network connection enabling component), enabling IR thermometer 210 to communicate over communication network 116 with one or more medical practitioner workstations 122 and/or central system 130. In some cases, at least one of the connections are over the Internet.

IR thermometer 210 further comprises processing circuitry 220. Processing circuitry 220 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant IR thermometer 210 resources and for enabling operations related to IR thermometer 210 resources.

The processing circuitry 220 can comprise a built-in self-test management module 260.

Built-in self-test management module 260 can be configured to perform a built-in self-test process, as further detailed herein, inter alia with respect to FIG. 4.

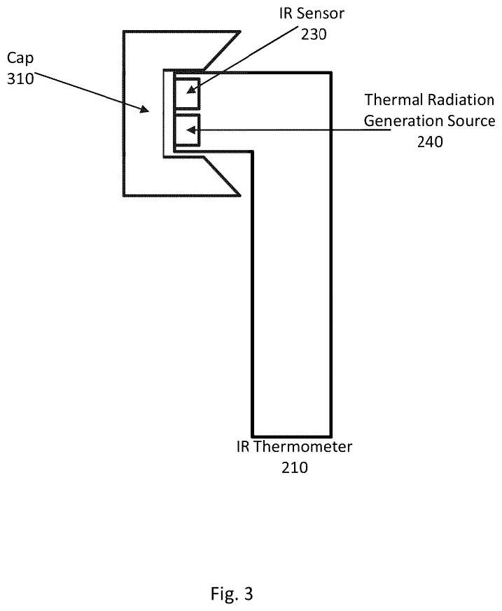

FIG. 3 is a schematic illustration of an example environment of a system for an IR thermometer with a built-in self-test, in accordance with the presently disclosed subject matter.

IR sensor 230 and thermal radiation generation source 240 can be located in an outer portion of the IR thermometer 210. The IR sensor 230 can measure thermal radiation coming from outside the IR thermometer 210. Thermal radiation generation source 240 can generate thermal radiation in an outward direction—away from IR thermometer 210.

Cap 310 can be a cap with internal reflective material (e.g., one or more mirrors, reflective film, etc.) that can be closed around the outer portion of the IR thermometer 210. Cap 310 can also isolate IR sensor from external thermal radiation.

When cap 310 is in the closed position, it reflects the radiation emitted by thermal radiation generation source 240 back to IR sensor 230 and isolates IR thermometer from external thermal radiation, external to the thermal radiation emitted by thermal radiation generation source 240, thus IR sensor 230 is expected to measure the radiation created by thermal radiation generation source 240 only. For this purpose, the thermal radiation generation source 240 is required to emit the thermal radiation, at least, in wavelengths that can be sensed by the IR sensor 230.

Attention is drawn to FIG. 4, a flowchart illustrating one example of a sequence of operations carried out for performing a built-in self-test, in accordance with the presently disclosed subject matter.

According to certain examples of the presently disclosed subject matter, IR thermometer 210 can be configured to perform a built-in self-test process 400, e.g. utilizing the built-in self-test management module 260.

As detailed above, IR thermometers 210 are sensitive to dirt or dust accumulating on at least parts of the IR sensor 230 and/or on lenses used to focus the measured infrared thermal radiation on to a detector of the IR sensor 230 and/or on any other part of the IR sensor 210 that is on the path of the thermal radiation emitting from the measured object and measured by the IR sensor 210, thus distorting the IR thermometer 210 readings. For example: ear wax can accumulate on the IR sensor and/or on the lens of an IR thermometer 210 used to measure tympanic temperature. The ear wax can cause the IR thermometer's 210 readings to be lower than the actual tympanic temperature. Performance of built-in self-test process 400 tests JR thermometer 210 for such distortions in the temperature readings.

For this purpose, IR thermometer 210 can be configured to instruct the thermal radiation generation source 240 to emit a known thermal radiation level, when the cap 310 is in the closed position (block 410). In some cases, cap 310 being in the closed position reflects the radiation emitted by thermal radiation generation source 240 back to IR sensor 230 and isolates IR thermometer from external thermal radiation, external to the thermal radiation emitted by thermal radiation generation source 240. For example, the thermal radiation generation source 240 can be a LED light that emits a given, pre-determined, known level of thermal radiation. It is to be noted that in some cases, due to the manufacturing processes of the LED light (or any other thermal radiation generation source 240 for that purpose), the known level of thermal radiation can vary, e.g., between one manufactured LED light to another, thus each LED light, or representative LED lights from respective manufactured groups of LED lights can be tested, as part of the production phase, to determine its specific known level of thermal radiation. In a non-limiting example, the given level of thermal radiation expected to be measured by IR sensor 230 as 37 degrees Celsius. In some cases, the given level of thermal radiation can be a, pre-determined, known range of thermal radiation levels. It is to be noted that in some cases the reflective material of cap 310 can reduce the amount of reflected radiation due to properties of the reflective material (e.g., by the reflective material absorbing part of the radiation emitted by thermal radiation generation source 240). In these cases, the given level of thermal radiation expected to be measured by IR sensor 230 can be corrected to compensate the reduction of the amount of reflected radiation due to properties of the reflective material.

After thus instructing the thermal radiation generation source 240, IR thermometer 210 can be configured to obtain at least one temperature measurement from the IR sensor 230 after a time period required for the thermal radiation generation source 240 to emit the known thermal radiation level or in some cases to emit thermal radiation that is in the pre-determined known range of thermal radiation levels (block 420). Continuing our non-limiting example, the thermal radiation generation source 240 emitted thermal radiation that are expected to be measured by IR sensor 230 as 37 degrees Celsius.

The at least one temperature measurement from the IR sensor 230 can be used to detect distortions of the readings by comparing the at least one temperature measurement and the temperature that are expected to be measured by IR sensor 130 from the given level of radiation or, in some cases, by comparing the at least one temperature measurement and a range of temperatures that are expected to be measured by IR sensor 130 from the given pre-determined known range of thermal radiation levels.

After obtaining the at least one temperature measurement, IR thermometer 210 can be configured to upon the temperature measurement deviating above a threshold from the expected temperature, generate a failure indication of failure of the built-in self-test or upon the temperature measurement deviating below the threshold from the expected temperature, generate a success indication of success of the built-in self-test (block 430). Continuing our non-limiting example, the threshold can be 1 degree Celsius, thus if the temperature measurement is less than 36 degrees Celsius a failure indication will be generated because the deviation of the temperature measurement from the temperature expected to be measured.

IR thermometer 210 can be optionally further configured to alert a user of the IR thermometer of the failure of the built-in self-test upon generating the failure indication (block 440). For example, by sounding a sound alert or by displaying a visual alert on a display of the IR thermometer 210.

IR thermometer 210 can be optionally further configured to provide a user of the IR thermometer with an instruction to clean the IR thermometer (block 450).

IR thermometer 210 can be optionally further configured to send results of the built-in self-test over a communication network to a medical practitioner workstation (block 460). In some cases, the results of the built-in self-test and/or the alert and/or the success indication and/or the failure indication can be communicated to a medical practitioner 124 that can be using a medical practitioner workstation 122 in a location remote from the IR thermometer 210, by sending the alert to the medical practitioner workstation 122 over communication network 116.

It is to be noted that, with reference to FIG. 4, some of the blocks can be integrated into a consolidated block or can be broken down to a few blocks and/or other blocks may be added. Furthermore, in some cases, the blocks can be performed in a different order than described herein (for example, block 450 can be performed before block 440, block 460 can be performed before block 450, etc.). It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. An Infra-Red (IR) thermometer with a built-in self-test, the IR thermometer comprising:
an IR sensor, located in an outer portion of the IR thermometer, configured to determine a temperature of an object based on thermal radiation emittance from the object;
a thermal radiation generation source, located in the outer portion of the IR thermometer, capable of emitting known thermal radiation upon receiving an instruction;
a cap, comprising a reflective surface for reflecting thermal radiation generated by the thermal radiation generation source into the IR sensor upon the cap being in a closed position wherein the cap is covering a part of the IR thermometer including the IR sensor and the thermal radiation generation source, so that the IR sensor does not receive radiation from sources other than the thermal radiation generation source; and
a processing circuitry configured to perform the built-in self-test by:
instructing the thermal radiation generation source to emit the known thermal radiation, when the cap is in the closed position;
obtaining at least one temperature measurement from the IR sensor after a time period required for the thermal radiation generation source to emit the known thermal radiation; and
upon the temperature measurement deviating above a threshold from the expected temperature, generating a failure indication of failure of the built-in self-test or upon the temperature measurement deviating below the threshold from the expected temperature, generate a success indication of success of the built-in self-test.

2. The IR thermometer of claim 1, wherein the processing circuitry is further configured to alert a user of the IR thermometer of the failure of the built-in self-test upon generating the failure indication.

3. The IR thermometer of claim 1, wherein the processing circuitry is further configured to provide a user of the IR thermometer with an instruction to clean the IR thermometer.

4. The IR thermometer of claim 1, wherein the thermal radiation generation source includes at least one Light-Emitting Diode (LED).

5. The IR thermometer of claim 1, wherein the processing circuitry is further configured to send results of the built-in self-test over a communication network to a medical practitioner workstation.

6. A method for a self-test of an Infra-Red (IR) thermometer comprising:
instructing, by a processing circuitry, a thermal radiation generation source of the IR thermometer, located in an outer portion of the IR thermometer, to emit a known thermal radiation, when a cap of the IR thermometer, is in a closed position, wherein the cap comprising a reflective surface for reflecting thermal radiation generated by the thermal radiation generation source into an IR sensor of the IR thermometer, located in the outer portion of the IR thermometer, the IR sensor configured to determine a temperature of an object based on thermal radiation emittance from the object, upon the cap being in the closed position wherein the cap is covering a part of the IR thermometer including the IR sensor and the thermal radiation generation source, so that the IR sensor does not receive radiation from sources other than the thermal radiation generation source;
obtaining, by the processing circuitry, at least one temperature measurement from the IR sensor after a time period required for the thermal radiation generation source to emit the known thermal radiation; and
upon the temperature measurement deviating above a threshold from the expected temperature, generating, by the processing circuitry, a failure indication of failure of the built-in self-test or upon the temperature measurement deviating below the threshold from the expected temperature, generate a success indication of success of the built-in self-test.

7. The method of claim 6, further comprising alerting, by the processing circuitry, a user of the IR thermometer of the failure of the built-in self-test upon generating the failure indication.

8. The method of claim 6, further comprising providing, by the processing circuitry, a user of the IR thermometer with an instruction to clean the IR thermometer.

9. The method of claim 6, wherein the thermal radiation generation source includes at least one Light-Emitting Diode (LED).

10. The method of claim 6, further comprising sending, by the processing circuitry, results of the built-in self-test over a communication network to a medical practitioner workstation.

11. A non-transitory computer readable storage medium having computer readable program code embodied therewith, the computer readable program code, executable by at least one processor of a computer to perform a method comprising:
instructing, by the processor, a thermal radiation generation source of the IR thermometer, located in an outer portion of the IR thermometer, to emit a known thermal radiation, when a cap of the IR thermometer, is in a closed position, wherein the cap comprising a reflective surface for reflecting thermal radiation generated by the thermal radiation generation source into an IR sensor of the IR thermometer, located in the outer portion of the IR thermometer, the IR sensor configured to determine a temperature of an object based on thermal radiation emittance from the object, upon the cap being in the closed position wherein the cap is covering a part of the IR thermometer including the IR sensor and the thermal radiation generation source, so that the IR sensor does not receive radiation from sources other than the thermal radiation generation source;
obtaining, by the processor, at least one temperature measurement from the IR sensor after a time period required for the thermal radiation generation source to emit the known thermal radiation; and
upon the temperature measurement deviating above a threshold from the expected temperature, generating, by the processor, a failure indication of failure of the built-in self-test or upon the temperature measurement deviating below the threshold from the expected temperature, generate a success indication of success of the built-in self-test.
